(19) United States
(12) Patent Application Publication
(10) Pub. No.: US 2019/0383275 A1
(43) Pub. Date: Dec. 19, 2019

(54) WIND POWER SYSTEM WITH LOW ELECTROMAGNETIC INTERFERENCE

(71) Applicant: LAGERWEY WIND B.V., Barneveld (NL)

(72) Inventors: André Heinz PUBANZ, Amersfoort (NL); Hendrik Lambertus LAGERWEIJ, Kootwijkerbroek (NL); Aart VAN DE POL, Otterlo (NL); Albèrt WAAIJENBERG, Barneveld (NL); Gustave Paul CORTEN, Koedijk (NL)

(21) Appl. No.: 16/480,086

(22) PCT Filed: Jan. 23, 2018
(86) PCT No.: PCT/NL2018/000004

§ 371 Date: Jul. 23, 2019

(30) Foreign Application Priority Data
Jan. 23, 2017 (NL) 1042236

(51) Int. Cl. F03D 80/60; F03D 15/20

(52) U.S. Cl. CPC F03D 80/60; F05B 2240/14; F03D 15/20

(57) ABSTRACT

A system comprising a receiving unit which is sensitive for electromagnetic radiation and one or more wind turbines, with a variable rotor speed, a rated power of more than 1 MW, a rotor diameter of at least 50 m, which one or more wind turbines are located at a distance of less than 20 km from said receiving unit and wherein said system is arranged for reducing the interference of the receiving unit by the electromagnetic radiation emitted and or reflected, by the one or more wind turbines, and in particular wherein said receiving unit comprises at least one antenna for receiving cosmic electromagnetic radiation in the frequency range between 10 Mhz and 250 MHz.

### BACKGROUND

### Technical Field

The present invention relates to a wind turbine with a low emission of electromagnetic radiation, to a system comprising both a receiving unit which is sensitive for electromagnetic radiation and one or more wind turbines with a low emission of electromagnetic radiation.

### Description of the Related Art

The emission of electromagnetic radiation, further on called EM-radiation, by wind turbines is usually not a problem since the turbines comply with international regulations limiting the emission levels. However for several specific cases the emission levels still hinders receiving units. A receiving unit can be any unit that subjectively or objectively is sensitive for EM-radiation (electromagnetic radiation). An example of such units are the antennas of the so-called LOFAR, a Low Frequency Array set up for receiving cosmic radiation within the bandwidth of 10 MHz to 250 MHz (MegaHertz). Another example form humans who claim to be sensitive to EM-radiation and sometimes experience hindrance. Some people claim that in general living species, both flora and fauna, are hindered by EM-radiation. Conclusively, even while wind turbines comply to regulations on emission levels, still many receiving units, experience hindrance by interference of EM-radiation emitted by wind turbines. This is an obstacle for the implementation of wind energy and thus for the transition to renewable energy.

A known basic solution for reducing the interference is to agree on certain periods wherein the wind turbines of a wind farm are stopped and/or switched off. Another known solution is that the installation of wind turbines is simply not permitted in certain areas. In both cases the result is that the implementation of wind energy is slowed down or that wind farms produce less energy and become uneconomic. A third way forward is that a wind farm is installed and that the complaints of people experiencing the hindrance directly or indirectly via other living species, are disregarded. This is of course an undesired way since it creates much resistance against wind energy.

### BRIEF SUMMARY

The present invention relates to a wind turbine with a low emission of electromagnetic radiation, to a system comprising both a receiving unit which is sensitive for electromagnetic radiation and one or more wind turbines with a low emission of electromagnetic radiation, which wind turbines can be located at a distance of less than 20 km from said receiving unit and to a method for optimizing said system and to a method for measuring the emission of electromagnetic radiation of a wind turbine

Furthermore, the implementation of wind energy is growing the last decades and wind turbines have been installed in the most suitable locations. Therefore other areas, sometimes quiet areas where to receiving units inter alia people with a high sensitivity for interference by EM-radiation have moved, are now considered for the installation of wind farms. The hindrance by EM-radiation emitted by wind turbines is therefore expected to increase.

Therefore there is a need to reduce the hindrance in an efficient way and in particular by a method which does not disregard complaints by humans and which does not severely hinder the implementation of wind farms.

According to one aspect of the invention it is proposed to install in areas wherein there is an objective or subjective sensitivity for interference by EM-radiation by wind turbines, a variable rotor speed wind turbine with a rated power of more than 1 MW (megawatt) and a rotor diameter of at least 50 m (meters) comprising several main parts such as a tower, a nacelle which may be integrated with a generator, a hub and at least one blade, further comprising a transformer and a main converter for adapting the variable frequency of the generator power to the grid frequency, wherein the wind turbine is arranged to reduce EM-radiation in particular in the range between 10 Mhz and 250 Mhz.

In an embodiment of the invention, further on denoted as ‘in an embodiment’, the wind turbine is arranged to reduce the emission of EM-radiation when any or more parts of the wind turbine are arranged to reduce emission of EM-radiation. In another embodiment the wind turbine is considered as a source of EM radiation which is arranged to reduce the equivalent isotropically radiated power in the frequency range between 30 MHz and 230 MHz to a level below 2.5 pW/Hz (picoWatt per Hertz) and in particular below 0.25 pW/Hz and more in particular below 0.025 pW/Hz and even more in particular below 0.0025 pW/Hz. In again another embodiment the wind turbine is arranged to reduce the emitted EM field strength limit in the frequency range between 30 MHz and 230 MHz in a bandwidth of 120 kHz (kilohertz) at a distance of 30 m from the nacelle to a level below 24 dμV/m (decibels microvolt per meter), in particular below 18 dμV/m and more in particular below 12 dBμV/m and even more in particular below 9 dBμV/m.

In an embodiment the wind turbine comprises a first main part and a second main part, which parts are pivotally connected to each other and wherein said parts comprise a shield for EM-radiation, which shields enclose apparatus which can be a source of EM-radiation, wherein said shields are conductively connected to each other in particular via slip rings so that the shields form a common shield, which may be a closed common field.

In an embodiment the shield of the first main part and possibly also that of the second main part is continued to a certain extent or fully to the center of rotation of the pivotal connection and grounded or interconnected to the adjacent shield. Continued to a certain extent can be defined as extended to the center of rotation to less than 1 m away from it, in particular to less to than 0.6 m and more in particular to less than 0.3 m. The advantage of this layout is that the shield itself may form a closed surface for EM-radiation with a bandwidth between 10 MHz and 250 MHz. In the case of two adjacent shields of two main parts which are pivotably connected, the advantage is that less or even non-conductive connections (e.g., slip rings, brushes or liquid metal based contacts) between the shields are required to close the shields. In an embodiment a gallium based alloy is used instead of mercury for at liquid metal based contact.

According to an embodiment, a shield is closed at the location where two main parts are pivotally connected. The shield may have a passage for maintenance people or for transporting service parts. This passage can have the shape of a door or a hatch and may be shielded itself.

The main parts refer to the tower, the nacelle including at least the stator of the generator, the hub possibly including the rotor of the generator and any of the blades. Two main parts which are pivotably connected refer to the tower and the nacelle, the nacelle or the generator, the nacelle and the hub or the hub and a blade.

The shields may comprise unshielded areas with a maximum unshielded distance of less than 1 m, in particular less than 0.3 m and more in particular less than 0.1 m and preferably less than 0.03 m. Any of the shields furthermore may be a separate shield or may be integrated with another part of the wind turbine. E.g., without limitation, the housing of the generator may serve both as a shield for EM-radiation and as a housing. Also the outer surface of the nacelle may be integrated with a shield against EM-radiation. Such a shield may furthermore have other functions such as without limitation a structural function or lightning protection.

In an embodiment, the wind turbine comprises at least two main parts which can pivotably move with respect to each other and which each comprise a shield for EM-radiation wherein said shields are grounded and have an overlap of at least 10 cm and in particular of at least 30 cm and more in particular of at least 1 m.

In an embodiment, the wind turbine comprises two main parts wherein the first main part comprises a stator of the direct drive generator and the second main part, which is pivotably connected to the first main part, comprises a rotor of the direct drive generator, wherein both main parts comprise a shield against the emission of EM-radiation which shields border to each other along a closed curve around the rotation axis of the generator along which closed curve the shields are electrically connected wherein the largest distance between the electrical connections, such as said slip rings, brushes or liquid metal based contacts, or any other known electrically conductive connections, measured along the curve is less than 1 m, in particular less than 0.3 m and more in particular smaller than 0.1 m.

Advantageously, the wind turbine further comprises a hatch with a hatch-shield for EM-radiation which hatch-shield borders to a shield for EM-radiation which is a separated or integrated part of a main part or the foundation and wherein said hatch-shield comprises one or more electrically conductive joints to said shield, wherein in the case of multiple joints, the largest distance between the joints measured along the closed curve along which the hatch-shield borders to the shield is less than 1 m, in particular less than 0.3 m and more in particular smaller than 0.1 m. It should be noted that the word hatch may refer to any opening in the wind turbine. So an opening such as, e.g., a door, a ventilation opening, an inspection hole or a man hole any of which can be located in the tower, in the foundation, in the nacelle, in the hub or in a blade may be considered as a hatch.

In an embodiment, the nacelle and or the hub of the wind turbine enclose electronic equipment wherein said equipment is enclosed in all directions or in all but the downward direction by a grounded conductive surface which may comprise unshielded areas which are smaller than 1 m2, in particular less than 0.3 m2 and preferably are less than 0.1 m2.

In an embodiment, the outer surface of the nacelle and a shield for EM-radiation are integrated and in particular the nacelle comprises a metal outer surface or a surface of a composite integrated with a conductive material that shields EM-radiation.

In an embodiment, the wind turbine comprises at least one power cable between the main converter and the transformer, wherein the length of said power cable is less than 20 m, in particular less than 10 m and preferably less than 5 m. It was shown that in particular power cables connected to the main converter are a source of EM-radiation and that the transformer damps the EM-radiation, therefore it is advantageous to install the converter close to the transformer so that the length of the cables over which EM-radiation is emitted can be reduced.

In a further beneficial embodiment, the power cables between the converter and the transformer and in particular also those between the converter and the generator are low pass filtered, between phases and earth and/or phase to phase, with a cut off frequency of less than 50 MHz and in particular of less than 10 MHz in order to respectively reduce the common mode signals and the differential mode signals. Such a low pass filter can be an electronic circuit comprising a capacitor connecting the phases to the ground or to each other. Another possibility is to apply a sinusoidal filter to the phases connected to the converter.

In an embodiment, at least one power cable to the main converter and in particular all power cables thereto are surrounded by one or more a ferrite cores which may be magnetic. Preferably any of the one or more ferrite cores is installed near the main converter for example at less than 1 m away from it. Advantageously the ferrite core is enclosed by a conductive surface which is grounded. Note that the application of ferrite cores around all cables to the main converter, thus also non-power cables, effectively reduces EM-emission. The same measures are useful for the other smaller converters in the wind turbine, such as converters in power supplies, converters for driving the yaw or pitch motors or those for driving cooling pumps or fans. The term converter in this description may also refer to an inverter, a servo drive, an electrical drive or a frequency converter.

In an embodiment, the wind turbine can be switched to a low EM-radiation emission mode wherein the main converter is switched off permanently or the main converter power circuits are not activated. In an embodiment other converters such as those for the yaw and pitch motors are switched off during periods wherein interference should be reduced at least for 50% of the time, in particular for at least 90% of the time and more in particular during the entire period. A receiving unit such as LOFAR is reducing EM interference by averaging, therefore short periods of converter activity are acceptable and at the same time sufficient to keep the wind turbine aligned with the wind by yawing and controlling the power of the turbine by pitching. In a further embodiment the wind turbine can be operated in a special fixed rotation speed mode, wherein the converter in the power circuit is inactive and the generator is coupled directly to the grid. For example in the case of a wind turbine with a doubly fed generator this is a realistic option. Advantageously, the pitch angles of the blades of the turbine are adjusted more towards vane position than usual in the case of fixed rotor speed operation, so that overpowering is avoided.

In an embodiment, the yaw and pitch motors of the wind turbine are operated without an converter, and advantageously, to avoid high peak currents a soft starter can be applied to drive the yaw and pitch motors and the relays which start and stop the motors can be low-pass filtered.

In an embodiment, the main converter is installed in the lower quarter of the tower and one or more power cables connect the main converter to the generator wherein the one or more power cables comprise shields which are grounded to the tower at a certain distance from the converter and at a certain distance from the generator wherein said certain distance is less than 10 m, in particular less than 3 m and more in particular less than 1 m. Preferably the shields of the cables are directly grounded to the shield of the converter. Embodiments of such a cable shield are a conventional cable shield made of meshed conductive wire, braid or foil or a constructional part like a conductive pipe or metal cable tray which is fixed to the tower wall or nacelle. The cable shields may be external shields or may be integrated with the insulator of the cable.

In an embodiment, the lightning arrestor assembly of the wind turbine with receptors on the nacelle and in the blades and a lightning cable from said receptors to the tower comprises at least one spark gap over which an electronic circuit avoids static discharges over the gap by conducting the charge over the gap. In an advantageous embodiment the resistance of the electronic circuit at a higher voltage over the circuit is lower than that at a lower voltage over the circuit, so that low voltage signals associated with EM-radiation are not passed through the gap into the blades. Such an electronic circuit may comprise a surge protector which may comprise a zener diode or a varistor, e.g., of the metal-oxide type.

In an embodiment of the wind turbine, the electronic equipment installed on the outside of the tower or the nacelle such as anemometers, wind vanes, beacon lights or LIDAR equipment is shielded for EM-radiation. The equipment can be shielded by covering it by a grounded conductive surface or mesh. Alternatively the equipment can be installed in a surrounding shape comprising gauze wherein the size of the meshes is less than 1 m×1 m and in particular less than 0.3 m×0.3 m and more in particular less than 0.1 m×0.1 m.

In an embodiment, the blades or the tower of the turbine are covered by a layer of paint which is optimized to absorb EM-radiation so that the contribution of reflected EM-radiation is less. Alternatively the blades may have a conductive surface which is grounded.

### System

According to an aspect of the invention, a system is proposed comprising a receiving unit which is sensitive for EM-radiation and one or more wind turbines, which wind turbines are located at a distance of less than 20 km from said receiving unit and wherein said system is arranged for reducing the interference of the receiving unit by the EM-radiation emitted and or reflected by the one or more wind turbines and in particular wherein said receiving unit comprises at least one antenna for receiving cosmic EM-radiation in the frequency range between 10 Mhz and 250 MHz. The receiving unit should be explained broadly: it may be a technical device or a human being or any living animal or plant which is objectively or subjectively sensitive to the EM-radiation emitted or reflected by any of the one or more wind turbines. In one embodiment the receiving unit comprises a spatial array of antennas which is sensitive to EM-radiation.

With the wind turbines or the system, the implementation of wind energy gets better acceptance which favors the realization of wind farms when the effects of EM-radiation are taken seriously, independent of the objective determination of the effects. A breakthrough thought is to reduce the EM-radiation emitted by wind turbines to a much higher degree than prescribed by regulations and also to reduce the EM-radiation below levels which are scientifically proven to be harmful for living species and humans in particular. The surprising result of this step which may be seen as irrational from scientific point of view is that it favors the implementation of wind energy and takes away much resistance.

In an embodiment of the system, a selection of the one or more wind turbines are deliberately switched to a modus of lower EM interference depending on the contribution per wind turbine. Such a modus of lower EM interference can be an operational mode wherein the use of converters is minimized or can mean that a turbine is switched off possibly with the exception of safety devices. The advantage of this embodiment is that it reduces the interference to acceptable levels for the receiving unit by only changing the operational modus of the selection of wind turbines which largely contributes to the interference and leaves other turbines unaffected, so that they still produce energy. In other words, instead of switching all turbines off which are part of the system and losing all the power, the power reduction is minimized and the interference level is still acceptable.

In an embodiment, the system also has a processing unit which receives information from both the receiving unit and from the one or more wind turbines and controls the receiving unit and or the one or more wind turbines so that said interference is reduced in particular by switching any of the one or more wind turbine to a modus of lower EM interference. In an embodiment, when the modus of low interference refers to a halted condition, the stand of any of the one or more wind turbines which is determined by the yaw angle of the nacelle, the azimuth angle of the rotor and the pitch angle of at least one blade can be chosen to be a stand corresponding to minimal interference. Advantageously the system has a processing unit which receives information from the one or more wind turbines and from the receiving unit and uses this information to optimize the system by reducing the interference and maximizing the earnings of the wind farm. For example the processing unit can adjust the stand of the wind turbines. According to another example wherein several turbines are switches off to reduce interference and suddenly the receiving unit malfunctions, then the processing unit can immediately use this information to switch on the turbines. Another example is that the processing unit can pass information on the stand of any of the one or more wind turbines to the receiving unit. This information may be an advantage for the receiving unit since it can compensate better, for example by filtering, for the reflection of EM-radiation once the stand of the turbines is known.

In an embodiment, the system is arranged such that when a wind turbine is stopped to reduce the interference, it is stopped in a stand which is regarded to be a safe position for the wind turbine. Note that when a wind turbine is parked in a position which is regarded as safe that this allows for switching safety devices to a mode of lower activity, including the mode of no activity, which can further reduce EM-radiation.

In an embodiment, the system comprises a measuring tool or estimating algorithm, which can be an additional tool or can be integrated in the receiving unit. This measuring tool is arranged to measure the EM-radiation emitted from any of the one or more wind turbines and in particular the radiation emitted from any of the one or more wind turbines and directed towards the receiving unit in order to use this measured EM-radiation to reduce the interference. The measured data can be used to filter the data collected by the receiving unit. Advantageously the measured data is used to discriminate the EM-radiation per wind turbine so that the wind turbines with the highest contribution to the interference can be traced and subsequently switched to a modus of lower interference. Another advantageous embodiment is that wherein said measurement tool passes the collected data or results thereof to the processing unit.

In an embodiment, the system further comprises at least an antenna, e.g., an array of antennas and an electronic device for receiving and processing EM-radiation. The electronic device can filter the received signals live or retrospectively based on data of the wind turbines such as per wind turbine the power, the rotor-rpm, the rotor azimuth and the blade pitch angles versus time, so that the interference is reduced and or the receiving units data quality is improved.

In an embodiment, the system is used to measure the EM-radiation and in the case the EM-radiation is still causing interference to reduce the EM radiation emitted or reflected by any wind turbine for example by improving the shielding of a wind turbine or by changing the stand of the turbine or by reducing the sources of radiation or by changing operational parameters of the turbine or of the system.

In the public literature, ‘Verstoring van het elektromagnetische milieu ter plaatse van de LOFAR kern door het windturbinepark Drentse Monden en Oostermoer,’ no. 2016-09190001 by Agentschap Telecom, it is proposed to apply an overgrown wall as shield against EM-radiation. Such a wall, however, has several disadvantages. It is expensive to realize since it may needs to be tens of meters high. Furthermore, because it necessarily has a wide base, much ground has to be moved while only the upper part of the wall shields the EM-radiation of the turbine effectively. Furthermore, if the wall turns out to shield the cosmic radiation which is studied by the receiving unit, it is expensive to remove the wall. Therefore a simple test to check the effectiveness of such a wall by installing a wall temporarily is not realistic.

Surprisingly, the embodiment of a system including a mesh, e.g., installed between posts does not have said disadvantages. It shields the antennas effectively against EM-radiation of the wind turbines. The mesh is cheaper than a wall, it can be removed or relocated easily. And surprisingly, opposite to the wall-option, it needs less material near the ground than at higher altitudes: it can even be open near the ground so that material is saved. For two reasons the mesh can be open near the ground: First only a small contribution of the disturbing EM-radiation from the turbines enters the antennas in an about horizontal direction since the ground damps the signals and second, because the EM-radiation is for a main part emitted or reflected by the higher parts of the turbine like, e.g., the blades, the hub and the nacelle. According to an advantageous embodiment the mesh shield is installed nearer to the receiving unit than to the most nearby wind turbine. The ratio between the distance to the turbine and that to the receiving unit should be at least 3 and in particular at least 10. Favorably the mesh shield is arranged to shield EM-radiation in the range between 10 MHz and 250 MHz. In a favorable embodiment the mesh shield is at least installed between the receiving unit and the most nearby turbine and in particular also between the receiving unit and second most nearby turbine. In the case that the receiving unit comprises more than one antenna, multiple meshes can be arranged to shield any of those antennas.

In an embodiment of the system, the periods wherein any of the one or more wind turbines are switched to a modus of reduced energy production in order to reduce the interference are selected in favor of the financial yield of the one or more wind turbines. Advantageously the periods are chosen during intervals of wind speeds with an associated low energy production, for example at wind speeds below 8 m/s, in particular below 7 m/s and more in particular below 6 m/s. Also the period may be chosen during periods of high wind speed wherein the turbines need to be switched off or have a high probability to be switched off to avoid overloading, for example wind speeds above 20 m/s and in particular above 25 m/s. The wind speeds may refer to the actual wind speeds or to expected wind speeds or to expected average wind speeds in a period wherein the interference should be minimized. In both the low wind speed and high wind speed conditions, the expected financial yield is low. Sometimes the expected or average wind speeds are in the range wherein much energy is produced while the price of energy is low, for example when many wind turbines in the neighborhood are producing much so that there is overproduction on the grid. Also such conditions are favorable periods to perform measurement with the receiving unit and to switch off certain turbines in order to reduce interference. Another example is that wherein maintenance of the wind turbines is scheduled during periods wherein the interference should be low. This will reduce maintenance during other periods and thus increase the availability of the wind turbines in periods wherein interference is not an issue, so that the produced energy is higher. In an embodiment, the scheduling of the periods of low interference and the maintenance work is optimized by using the argument that the financial yield of the wind turbines is optimized or that the energy yield of the turbines is optimized.

One embodiment wherein the processing unit can improve the system is that wherein, during a period wherein the receiving unit is operational and one or more wind turbines are switched to a mode of reduced emission of EM-radiation, for a certain reason, e.g., malfunctioning of the receiving unit, there is no need to continue the scheduled period and thus that the wind turbines can be switched to normal operation again. In this case the processing unit can perform the switching of the turbines between operational modes, e.g., based on information from the receiving unit, so that the efficiency of the system as a whole increases.

In an embodiment, the operational period of the receiving unit is communicated to disturbing devices other than the one or more wind turbines so that these devices can be switched to a lower emission mode or can be switched off. The advantage is a lower interference level or that less turbines need to be switched to a low emission mode and still an acceptable level of interference is realized.

An embodiment of the invention further comprises an antenna which is fixed to the wind turbine in particular at a height of at least 50% of the height of the wind turbine axis above ground level. An interpretation of the term ‘fixed to’ is that the antenna has at least one structural connection to the wind turbine and in particular that this connection supports in elevating the antenna above ground level. This antenna is arranged to measure the emission and or the reflection of EM-radiation by the wind turbine. Such a measurement setup is useful for example for determining the effectiveness of the different measures to reduce EM-radiation, to determine the conformity of the turbine to certain EM-emission levels or to use the measured data as input to optimize the system. The antenna can be fixed to, e.g., by a structure such as a rod possibly stiffened by stay, which structure is fixed to the wind turbine. In particular, the structure is fixed the nacelle, to the generator or to the hub, so that it follows the yaw motion of the nacelle and the risk of a collision between the blades and the structure is minimal. In another favorable embodiment the structure is fixed to the tower of the turbine so that it does not follow the yaw motion so that it can be used to measure the tangential distribution about the yaw axis of the EM-emission by the yawing part of the turbine. In an embodiment the antenna is fixed to a rope between the wind turbine and the ground. The rope may be fixed to the ground at a position between 50 m and 500 m from the tower bottom. The antenna may be fixed to the rope via a structure comprising a rod which is fixed to the rope and carries the antenna at one end and has a counter weight at the other end. Instead of a counter weight also another line from the lower end of the rod to the ground can be applied. In an embodiment the antenna is fixed at a distance from the turbine yaw axis of less than 100 m and more in particular of less than 60 m and preferably at a distance of less than 40 m. In an embodiment the antenna is located at least 5 m and in particular at least 10 m from the nacelle. In an alternative embodiment an antenna is positioned near the wind turbine by a drone or a lighter than air vehicle such as a zeppelin or a hot air balloon or by a combination of those. A power line can supply the power to the drone from the wind turbine, e.g., from the nacelle or from the ground. The lighter than air vehicle also can be kept in position by one or more lines between the vehicle and the ground or between the vehicle and the wind turbine.

### BRIEF DESCRIPTION OF THE DRAWINGS

The following drawings show exemplary embodiments of the invention:

FIG. 1 shows a wind turbine arranged to have low emission of EM-radiation.

FIG. 2 shows a wind turbine arranged to have low emission of EM-radiation.

FIG. 3 shows a system with a receiving unit and one or more wind turbines.

The drawings are to be understood not to be drawn on scale.

### DETAILED DESCRIPTION

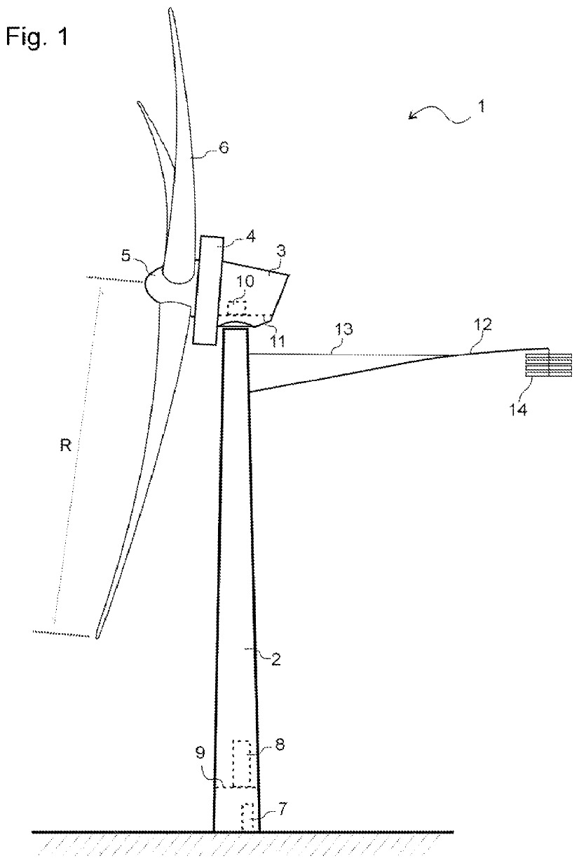

FIG. 1 shows an embodiment of a wind turbine arranged to have low emission of EM-radiation. The wind turbine comprises a tower 2, a nacelle 3, a generator 4, a hub 5 and at least one blade 6. Inside the nacelle is a platform 11 and electronic equipment 10. In the lower part of the tower another platform 9 is installed which carries the converter 8. The transformer 7 is installed at the tower bottom. The wind turbine is equipped with an antenna 14 to perform measurements of the emission of EM-radiation. The antenna is fixed to a rod 12 which is stiffened by stay 13. Both the rod and the stay are fixed to the tower 2.

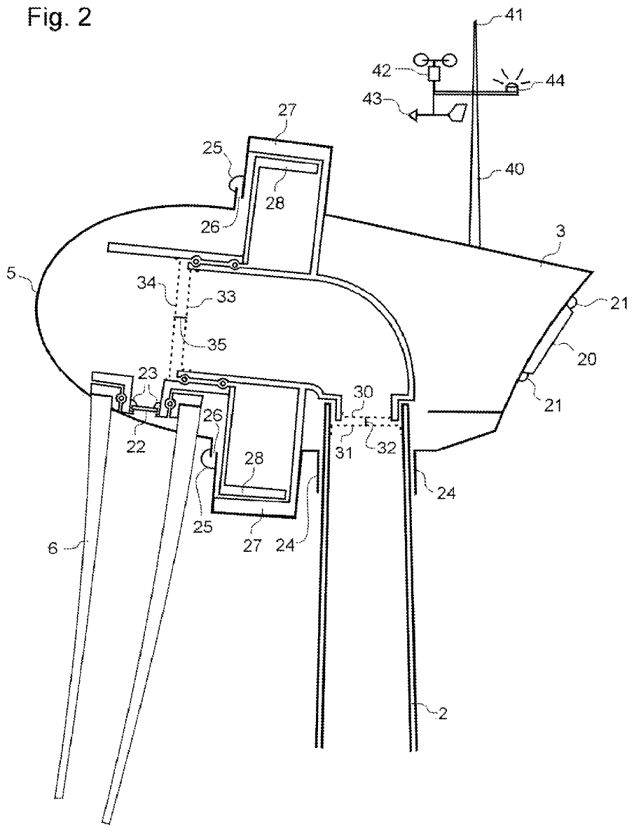

FIG. 2 shows an exemplary embodiment of the upper part of a wind turbine arranged to have low emission of EM-radiation. On the back of the nacelle a hatch 20 is installed which is by itself shielded against EM-radiation by a hatch shield which covers the hatch surface. The hatch shield is connected to the shield of the nacelle by electrically conductive joints 21. The blade root is closed by hatch 22 which also has a hatch shield which is connected by electrically conductive joints 23 to the shield of the hub.

The tower which is in this embodiment a shield by itself, e.g., because it is made of grounded steel plates and the nacelle which in this embodiment has an integrated shield can be joint in a manner which is arranged to reduce the emission of EM-radiation by applying an overlap 24.

The nacelle with the stator of the direct drive generator (27) is a main part and the hub with the rotor of the direct drive generator (28) is another main part, which main parts are pivotally connected. Both main parts comprise a shield against the emission of EM-radiation which shields border to each other along a closed curve 26 around the rotation axis. Along curve 26 the shields are connected by electrically conductive joints 25 which may be slip rings or other connections which allow relative movement.

The tower is a main part which is pivotably connected to the nacelle which is another main part. Near the pivotal connection the shield of the tower is continued by shield 31 to the center of the pivotal connection. Also the shield of the nacelle is continued by shield 30 to the center of the pivotal connection. The shields are connected via connection 32 which can be a cable which permits cable twisting during turbine yawing or by a slip ring type of connection.

Another embodiment of shields which continue to the center of a pivotal connection are the shields 33 and 34 which respectively continue the shield of the nacelle and that of the hub to the center of the rotor axis. The shields are connected by connection 35, which is an electrically conductive connection which allows rotation.

Three methods of connection different shields are illustrated: by overlapping 24, by using slip rings 23, 25 or by continuing shield in the direction of centers of rotation where a connection is made 30, 31, 32, 33, 34, 35. The application of the three methods is not limited to the positions in the wind turbine where they are drawn. At each position of any of the connections, any of the mentioned connections is possible.

FIG. 2 also shows a mast 40 which serves as a lightning receptor 41 and serves to mount equipment like a bacon light 44, an anemometer 42 and a wind vane 43. According to an embodiment of the invention all this equipment is shielded against the emission of EM-radiation by grounding the outer surface of all electronics. Also nettings which fully surround the equipment except of the lightning receptor effectively shield emission of EM-radiation. In an embodiment the mesh of the nettings is less than 1 m×1 m, in particular less than 0.3 m×0.3 m and more in particular less than 0.1 m×0.1 m. In an embodiment according to the invention the electronics of the equipment installed outside of the nacelle is connected to ground via a low pass filter with a cut off frequency of less than 10 MHz, in particular less than 100 kHz and more in particular of less than 1 kHz.

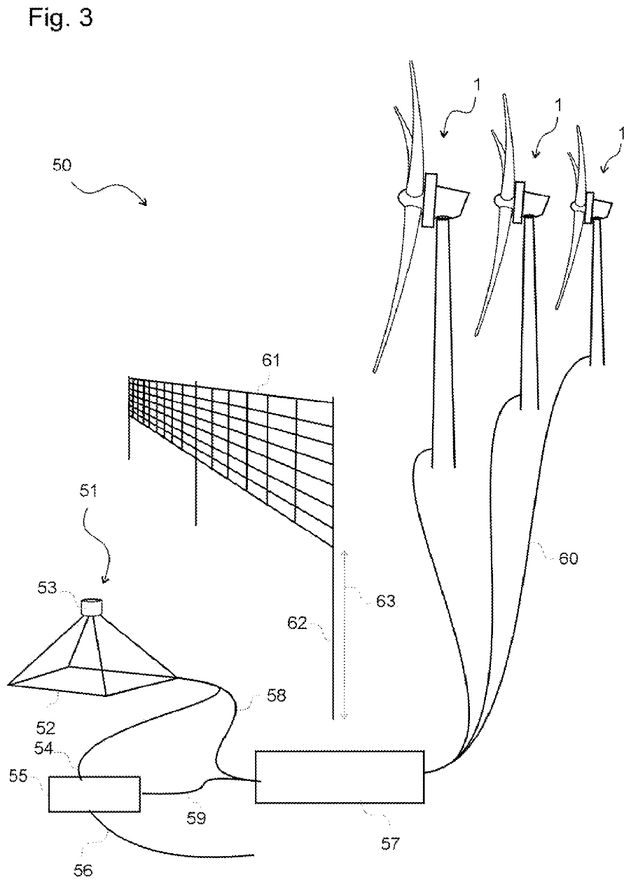

FIG. 3 shows an exemplary system 50 according to the invention, which system comprises a receiving unit 51 which is in this exemplary case comprises an antenna 52, a sensor 53 and an electronic and or optic circuit 55. The system further comprises several wind turbines 1 at a distance of less than 20 km and a processing unit 57 which can exchange data via a connection 60 with the wind turbines and via connections 58 and 59 with the receiving system. The connections are shown as physical connections however they can be wireless as well. The processing unit may use operational data of the turbines and forward it to the receiving unit to optimize filtering. The processing unit may also use operational data of the receiving unit and or of the measuring tool to optimally operate the turbines in order to minimize interference or to maximize financial revenues or to realize another optimum.

The system may comprise a shield similar to the gauze or mesh 61 in FIG. 3. The density of the mesh may increase with altitude over a certain vertical range and in particular the mesh starts at a certain distance 63 above the ground, which distance preferably is at least 2 meters. The mesh or gauze can be installed by any known method, e.g., by fixing it in between poles 62 and preferably it is installed at least in between an antenna and the most nearby wind turbine.

It is to be understood that in the present application, the term ‘comprising’ does not exclude other elements or steps. Also, each of the terms ‘a’ or ‘an’ does not exclude a plurality. Any reference sign in the claims shall not be construed as limiting the scope of the claims. The term ‘grounded’ in this text may refer to a direct connection to earth but also may refer to an indirect connection to earth, for example via another device. Such a connection may comprise a slip ring or another type of electrically conductive contact between parts which move with respect to each other. The term grounding may also refer to connecting to a conductive shield of a device. Finally the term grounding may refer to the connections of shields so that they form a larger shield.

1. A variable rotor speed wind turbine with a rated power of more than 1 MW (megawatts) and a rotor diameter of at least 50 meters, the variable rotor speed wind turbine comprising:
a tower,
a nacelle;
a generator;
a hub;
at least one blade;
a transformer; and
a main converter for adapting a variable frequency of a generator power to a grid frequency, wherein the wind turbine is arranged to reduce an emission of electro magnetic electromagnetic (FM) radiation in a range between 10 Mhz (megahertz) and 250 Mhz.

2. The wind turbine of claim 1, further comprising a first main part and a second main part, wherein the first and second main parts are pivotally connected to each other, and wherein the first and second main parts each comprise a shield for EM-radiation, wherein the shields are electrically conductively connected to each other via slip rings so that the shields form a common shield with unshielded areas with a maximum unshielded distance of less than 1 meter.

3. The wind turbine of claim 1, further comprising a first main part and a second main part, wherein the first and second main parts are pivotally connected to each other by a pivotal connection, and wherein at least one of the first and second main parts comprises a shield for EM-radiation, wherein near the pivotal connection, the shield extends towards a center of rotation of the pivotal connection and grounded by slip rings, wherein the shields comprises unshielded areas with a maximum unshielded distance of less than 1 meter.

4. The wind turbine of claim 1, further comprising at least two main parts configured to rotate with respect to each other, and wherein each of the at least two main parts have shields configured to shield for EM-radiation, wherein the shields are coupled to ground and have an overlap of at least 10 centimeters.

5. The wind turbine claim 1, further comprising first and second main parts that are pivotably connected together, wherein the first main part comprises a stator of the generator, wherein the generator is a direct drive generator, wherein the second main part comprises a rotor of the direct drive generator, wherein the first and second main parts comprise a shield against an emission of EM-radiation which shields border to each other along a closed curve around a rotation axis of the generator along which closed curve the shields are electrically connected, wherein a largest distance between electrical connections measured along the curve is less than 1 meter.

6. The wind turbine of claim 1, further comprising a hatch with a hatch-shield for EM-radiation which hatch-shield borders to a shield for EM-radiation which is a separate or integrated part of the hub, the nacelle, the tower, a foundation, or the at least one blade, and wherein the hatch-shield comprises conductive joints coupled to the shield, wherein, a largest distance between the conductive joints measured along a closed curve along which the hatch-shield borders to the shield is less than 1 meter.

7. The wind turbine of claim 1, wherein the nacelle and the hub enclose electronic equipment, wherein the equipment is enclosed by a grounded conductive surface with unshielded areas, wherein the unshielded areas have a maximum non-conductive range of less than 1 meter.

8. The wind turbine of claim 7, wherein an outer surface of the nacelle and a shield for EM-radiation are integrated together, and wherein the nacelle comprises a metal outer surface or an outer surface of a composite integrated with a conductive material that shields EM-radiation.

9. The wind turbine of claim 1, further comprising at least one power cable between the main converter and the transformer, wherein a length of the at least one power cable is less than 20 meters.

10. The wind turbine of claim 1, further comprising at least one power cable coupled to the main converter, wherein a power cable electrical signal is low pass filtered for common mode and/or differential mode signals with a cut off frequency of less than 50 MHz.

11. The wind turbine of claim 1, wherein at least one power cable connected to the main converter is surrounded by one or more ferrite cores, and wherein the one or more ferrite cores is enclosed by a conductive surface that is coupled to ground.

12. The wind turbine of claim 1, wherein the wind turbine is configured to be switched to a low EM-radiation emission mode, wherein the main converter is switched off permanently or main converter power circuits are not activated, and wherein converters for yaw and pitch motors are configured to be switched off during at least 50% of the time.

13. The wind turbine of claim 1, wherein the main converter is installed in a lower quarter of the tower and one or more power cables connect the main converter to the generator, wherein the one or more power cables comprise electrically conductive shields that are grounded to the tower at a particular distance from the converter and at a certain distance from the generator, wherein the particular distance is less than 10 meter.

14. The wind turbine of claim 1, further comprising a lightning arrester includes receptors on the nacelle and the blades and includes a lightning cable from the receptors to the tower, at least one spark gap in the lightning cable, wherein the at least one spark gaps comprises an electronic circuit arranged to decrease the emission of EM-radiation by static discharges, and wherein resistance of the electronic circuit at a higher voltage over the circuit is lower than that at a lower voltage over the circuit.

15. The wind turbine of claim 1, further comprising electronic equipment outside of the tower or the nacelle, wherein the equipment is shielded for EM-radiation, and wherein the equipment is covered by a grounded conductive surface or is at least partly surrounded by a conductive meshed surface.

16. The wind turbine of claim 1, wherein one or more of the at least one blade, the nacelle, or the tower are covered by a paint absorbing EM-radiation.

17. A system comprising:
a receiving unit that is sensitive to EM-radiation; and
one or more wind turbines according to claim 1, wherein the one or more wind turbines are located at a distance of less than 20 km from the receiving unit, wherein the system is arranged for reducing interference of the receiving unit by EM-radiation emitted or reflected by the one or more wind turbines, and wherein the receiving unit comprises at least an antenna for receiving cosmic EM-radiation in a frequency range between 10 Mhz and 250 MHz.

18. The system according to claim 17, wherein depending on a contribution per wind turbine to the interference, a selection of the one or more wind turbines are deliberately switched to a modus, wherein interference by EM-radiation is reduced, wherein the modus is based on a reduced activity of converters of a wind turbine.

19. The system according to claim 18, further comprising a processing unit configured to receive information from the receiving unit and from the one or more wind turbines and to control the receiving unit and the one or more wind turbines so that the interference is reduced by switching any of the one or more wind turbines to an operational mode with a reduced contribution to the interference and by controlling a stand of any of the one or more wind turbines, wherein the stand is determined by any of a yaw angle of the nacelle, an azimuth angle of a rotor and a pitch angle of at least one blade.

20. The system according to claim 19, further comprising a measuring tool arranged to measure the EM-radiation emitted from any of the one or more wind turbines.

21. The system according to any one of the claim 20, further comprising an antenna and a device for receiving and processing EM-radiation, wherein wind turbine data such as a generated power, a rotor rpm, a rotor azimuth and a blade pitch angles versus time of any of the one or more turbines are applied by the receiving unit to filter signals received by the antenna so that the interference is reduced.

22. The system according to claim 21, wherein a conductive mesh for shielding EM-radiation is installed in between any of the one or more wind turbines and the receiving unit, and wherein an average grid size of the conductive mesh close to the ground is larger than that at a larger altitude above the ground, and wherein a lower part of the mesh starts at 2 meters above ground level or higher.

23. A method comprising:
optimizing the system of claim 17, wherein optimizing comprises switching any of the one or more wind turbines to a modus of reduced energy production to reduce the interference and are selected in favor of a financial yield of the one or more wind turbines by choosing periods during intervals of wind speeds with a low energy production or during intervals, wherein price for the produced energy is low or during intervals in which wind turbine maintenance is scheduled.

24. The method of claim 23, comprising communicating a period in which the receiving unit is operational disturbing devices other than the one or more wind turbines so that disturbing devices can be switched to a lower emission mode or can be switched off.

25. A method comprising:
measuring the emission of EM-radiation of a wind turbine according to claim 1, wherein an antenna is fixed to the wind turbine at a location that is at least 50% of the height of the wind turbine axis above ground level.
